(19) United States
(12) Patent Application Publication
(10) Pub. No.: US 2025/0257886 A1
(43) Pub. Date: Aug. 14, 2025

(54) EVAPORATIVE COOLING SYSTEM FOR SUBSTANTIALLY ENCLOSED STRUCTURES

(71) Applicant: Portacool, LLC, Center, TX (US)

(72) Inventors: Patrick W. Van Deventer, Tyler, TX (US); Crawford Cannon, Tyler, TX (US); William David Daugherty, III, Gladewater, TX (US); James L. Allen, Sulphur Springs, TX (US)

(73) Assignee: Portacool, LLC, Center, TX (US)

(21) Appl. No.: 19/192,312

(22) Filed: Apr. 28, 2025

Related U.S. Application Data
(63) Continuation-in-part of application No. 18/236,670, filed on Aug. 22, 2023.

(51) Int. Cl. F24F 5/00; F24F 13/02; F24F 13/06

(52) U.S. Cl. CPC F24F 5/0035; F24F 13/0209; F24F 13/0254; F24F 13/06

(57) ABSTRACT

An evaporative cooling system (ECS) has an output direction system (ODS) having an outer housing, a nozzle configured to receive evaporatively cooled air from the ECS, and a mechanism for selectively moving the nozzle relative to the outer housing. The nozzle is located remote from the outer housing. A method of cooling a substantially enclosed structure includes providing an evaporative cooling system (ECS), operating the ECS to evaporatively cool air and eject the evaporatively cooled air, providing an output direction system (ODS), receiving the evaporatively cooled air from the ECS and into the ODS, transporting the evaporatively cooled air to a location remote from the ECS via the ODS, and outputting the evaporatively cooled air from the ODS through a nozzle.

### CROSS-REFERENCE TO RELATED APPLICATIONS

This application is a Continuation-In-Part of and claims the benefit of U.S. patent application Ser. No. 18/236,670 entitled “Stacked Evaporator Air Cooler” and filed 22 Aug. 2023, the entirety of which is hereby incorporated by reference.

### STATEMENT REGARDING FEDERALLY SPONSORED RESEARCH OR DEVELOPMENT

Not applicable.

### BACKGROUND

In the field of cargo transportation, substantially enclosed structures, namely, trailers, cargo containers, and the like, are utilized for storage and movement of goods. Often, the goods must be removed from the substantially encloses structures by people and machines. However, temperatures within the substantially enclosed structures can be uncomfortably or dangerously extreme for the people and/or machines. Accordingly, there is a need for cooling and heating the interior space of the substantially enclosed structures at least during loading and unloading activities within the substantially enclosed structures.

### BRIEF DESCRIPTION OF THE DRAWINGS

FIG. 1 is an oblique view of an evaporative cooling system (ECS) in a dock environment with an output direction system (ODS) in a stowed position according to an embodiment of this disclosure.

FIG. 2 is an oblique view of the ECS with the ODS configured to output through a left dock.

FIG. 3 is an oblique view of the ECS with the ODS configured to output through a right dock.

FIG. 4 is a front view of the ECS with the ODS configured to output through the left dock.

FIG. 5 is a front view of the ECS with the ODS configured to output through the right dock.

FIG. 6 is a rear view of the ECS with the ODS configured to output through the left dock.

FIG. 7 is a rear view of the ECS with the ODS configured to output through the right dock.

FIG. 8 is an oblique top-front view of a portion of the ECS without showing the ODS.

FIG. 9 is an oblique top-rear view of a portion of the ECS without showing the ODS.

FIG. 10 is an oblique top-front close-up view of a portion of the ECS without showing the ODS.

FIG. 11 is an oblique front-right view of a duct attachment of the ODS.

FIG. 12 is an oblique rear-right view of the duct attachment of FIG. 11.

FIG. 13 is an orthogonal front view of the duct attachment of FIG. 11.

FIG. 14 is an orthogonal rear view of the duct attachment of FIG. 11.

FIG. 15 is an orthogonal top view of the duct attachment of FIG. 11.

FIG. 16 is an orthogonal right view of the duct attachment of FIG. 11.

FIG. 17 is an oblique top-right view of a portion of the ODS in a deployed position and without showing a duct and the duct attachment.

FIG. 18 is an oblique top-right view of the portion of the ODS of FIG. 17 in a stowed position.

FIG. 19 is an oblique top-right view of a nozzle of the ODS.

FIG. 20 is an orthogonal front view of the nozzle of FIG. 19.

FIG. 21 is an orthogonal rear view of the nozzle of FIG. 19.

FIG. 22 is an oblique rear view of a portion of the ODS showing an attachment system of the ODS.

FIG. 23 is an oblique rear view of the portion of the ODS of FIG. 22 without showing the nozzle and a spacer.

FIG. 24 is a schematic view of the ECS of FIG. 1 in a shipping dock environment.

FIG. 25 is a computational airflow velocity analysis of air exiting the nozzle of FIG. 19 into a trailer.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

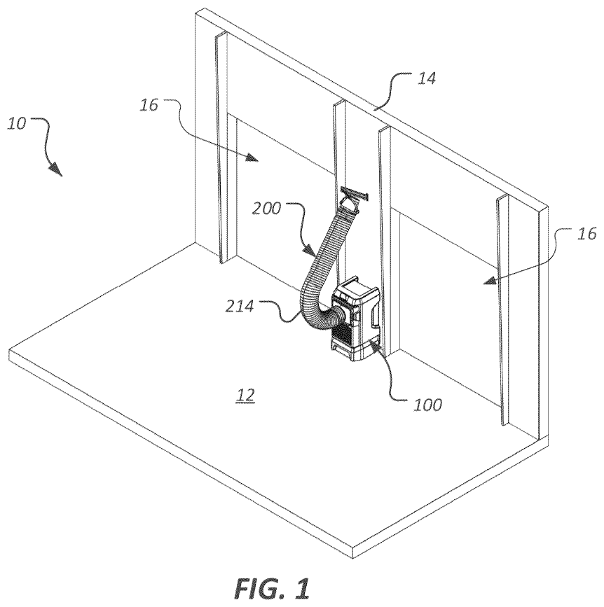

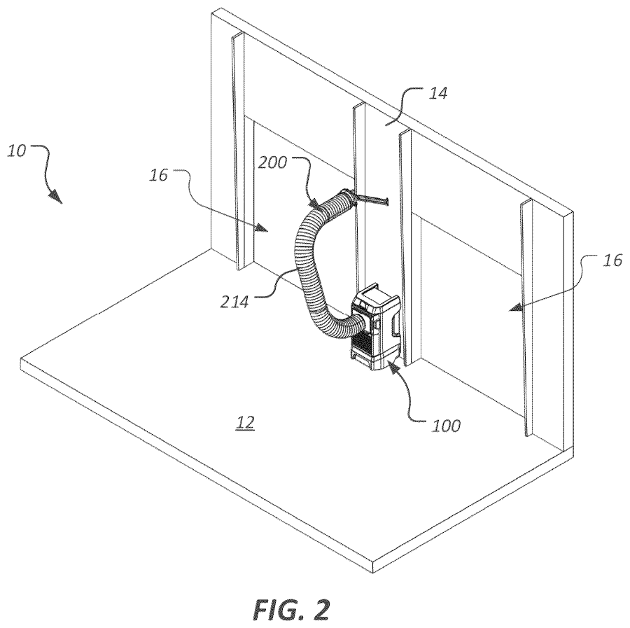

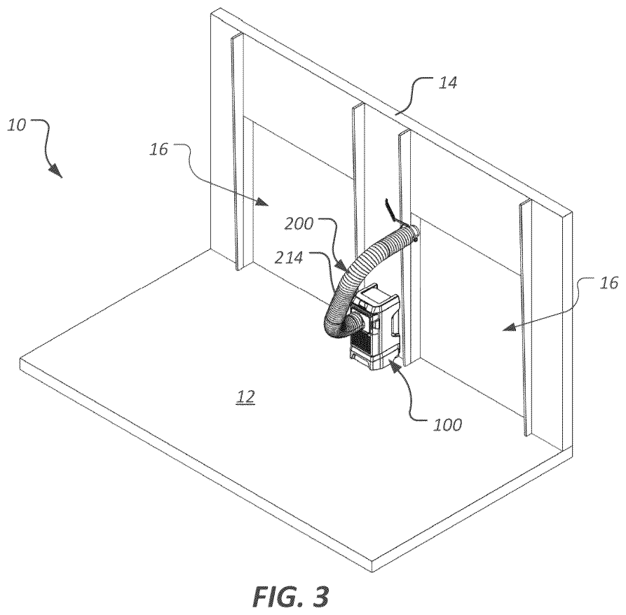

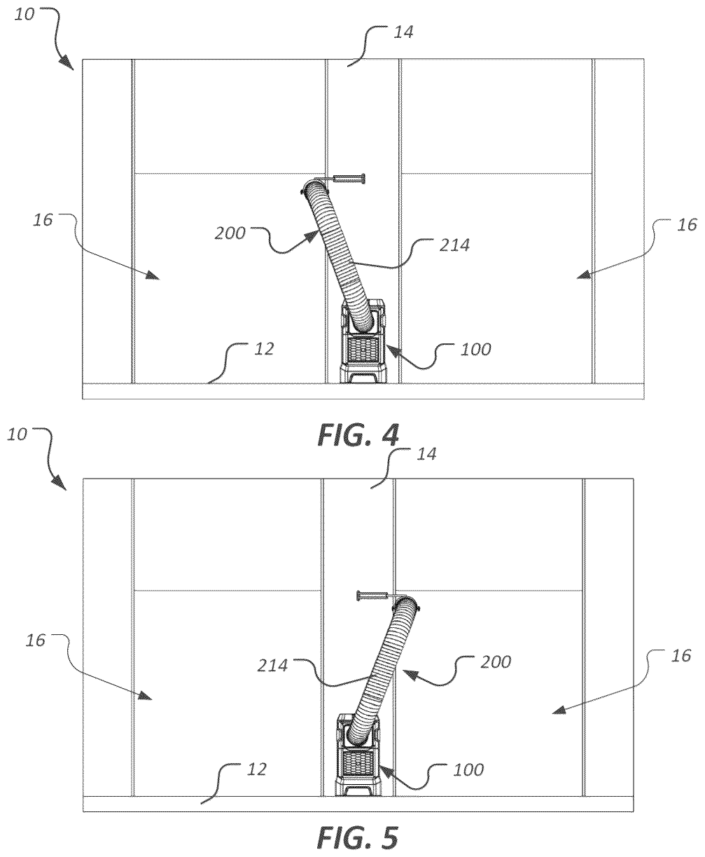

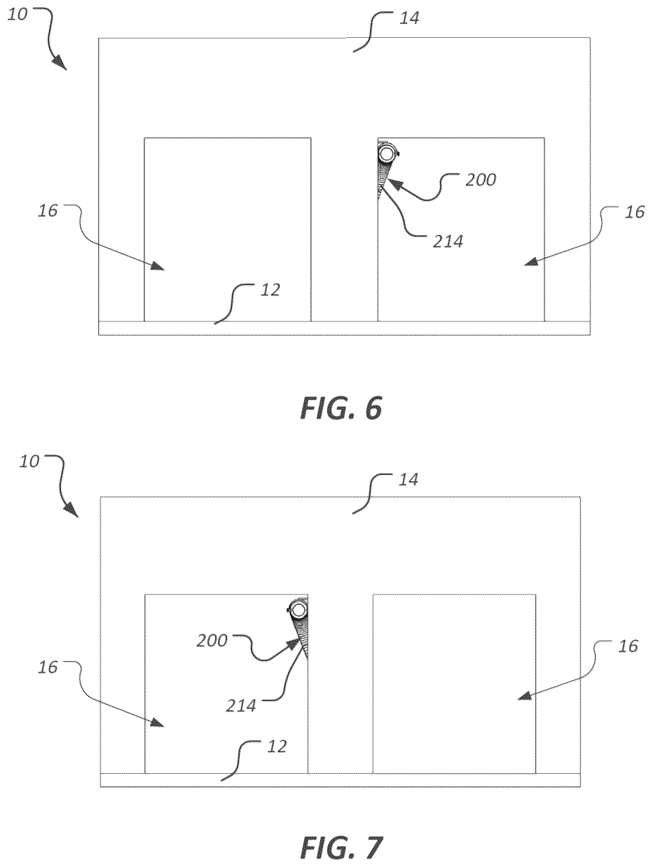

FIGS. 1-7 illustrate an evaporative cooling system (ECS) 100 having an output direction system (ODS) 200, according to an embodiment of this disclosure. In this embodiment, ECS 100 is substantially similar to the portable evaporator air cooler 100 of U.S. patent application Ser. No. 18/236,670 which is hereby incorporated by reference in its entirety. ECS 100 is shown as disposed in a shipping dock environment 10, such as a conventional shipping dock that is configured to allow cargo trailers to be loaded and unloaded. The shipping dock environment 10 comprises a floor 12, a wall 14, and dock doorways 16. In this embodiment, a portion of ECS 100 is movably disposed on floor 12 in alignment with a portion of wall 14 that is disposed between dock doorways 16. In this embodiment, output direction system (ODS) 200 is both connected to an outer housing 102 of ECS 100 and supported by wall 14.

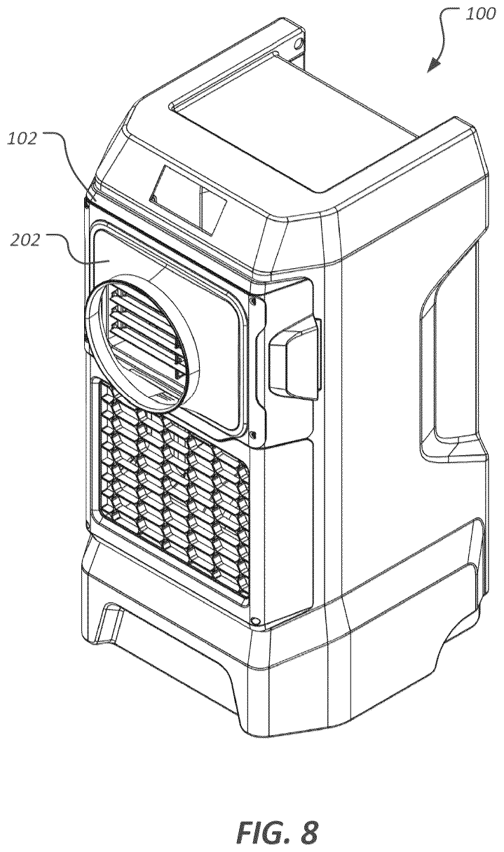

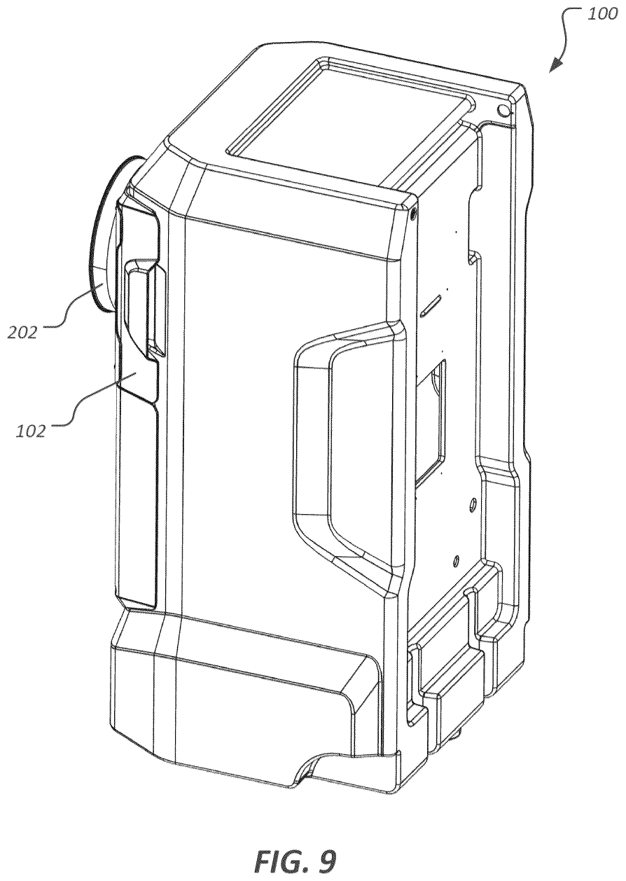

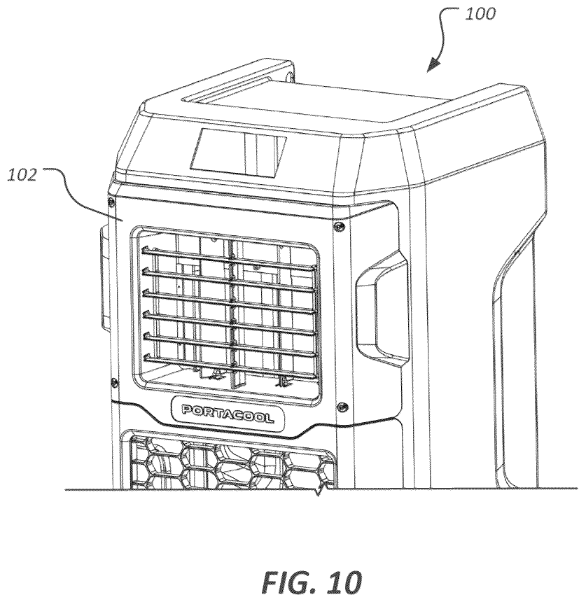

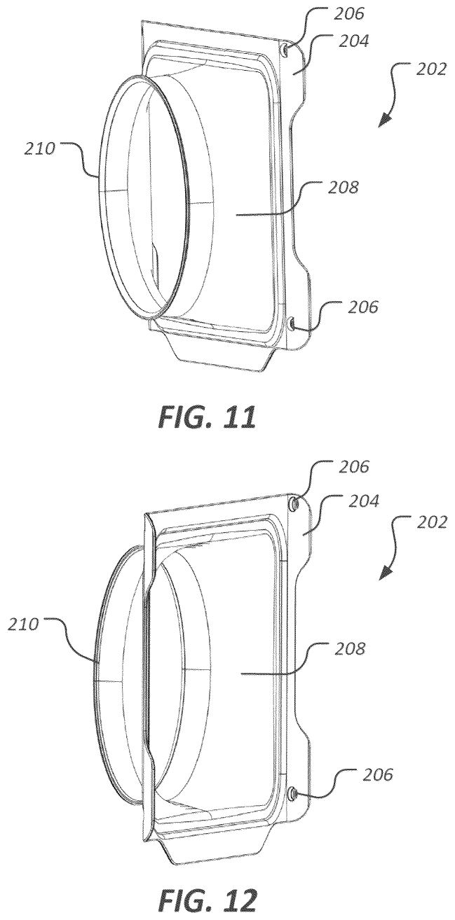

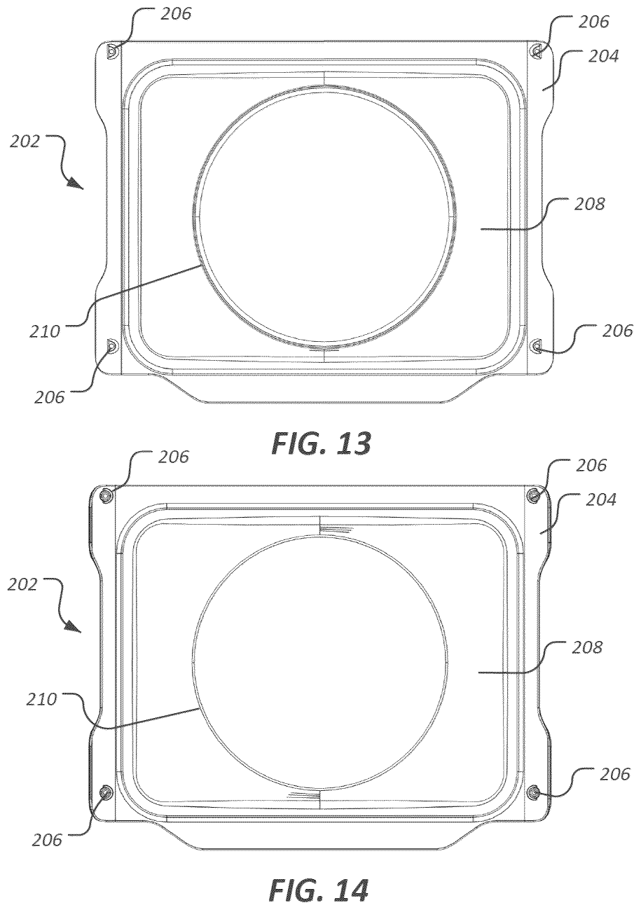

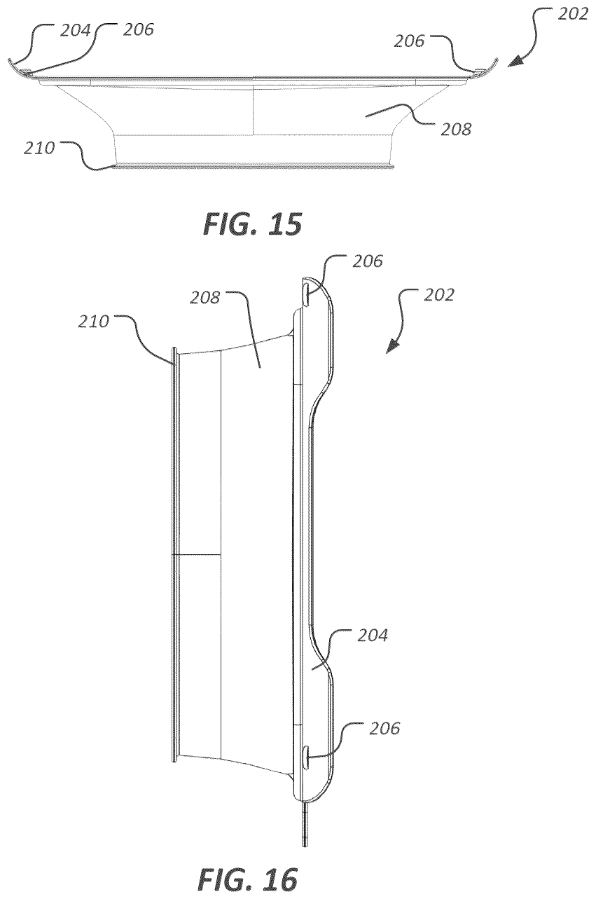

Referring to FIGS. 8, 9, and 11-16, ODS 200 comprises a duct attachment 202 configured for selective attachment to an outer housing 102 of ECS 100. A flange 204 of duct attachment 202 can be placed substantially flush against outer housing 102 so that air ejected from ODS 200 is pass through duct attachment 202. Air that is ejected from ECS 100 can pass through duct attachment 202 through an internal space defined by a converging wall 208 that extends from flange 204 to a duct connection ring 210. Notably, converging wall 208 comprises a profile that is substantially rectangular at the junction with flange 204 and extends away from ECS 100 in a manner that smoothly transitions to join with the substantially cylindrical tubular shaped duct connection ring 210. In this embodiment, duct connection ring 210 comprises a lip that can serve as a stop for retention devices used to attach a flexible duct 214 to duct connection ring 210. FIG. 10 shows ECS 100 with duct attachment 202 removed.

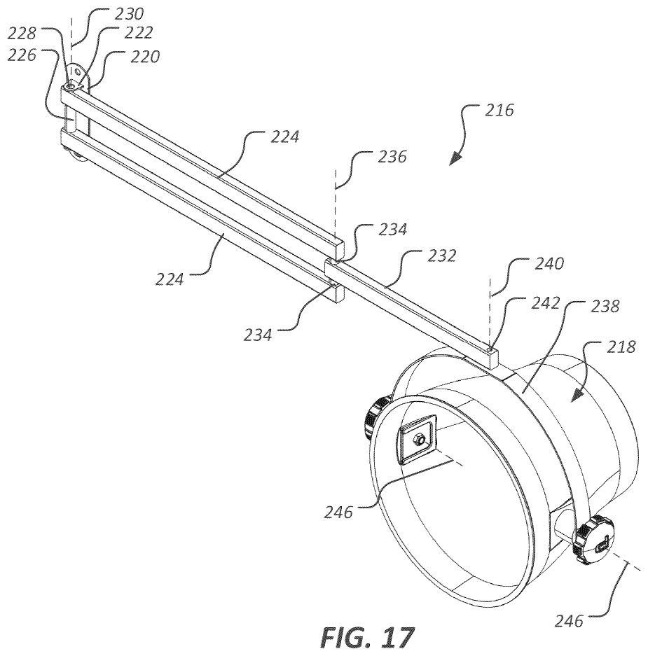

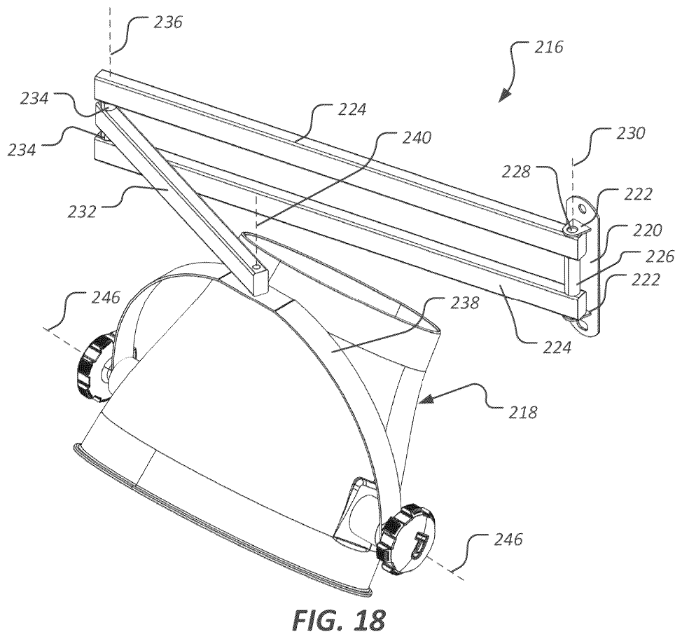

Referring to FIGS. 17 and 18, ODS 200 further comprises an adjustable arm mount system 216 and a nozzle 218 carried by arm mount system 216. Arm mount system 216 comprises a wall plate 220 for attachment to a wall such as wall 14. Wall plate 220 comprises flanges 222 for accepting base arms 224 and a wall spacer 226 therebetween. Flanges 222, base arms 224, and wall spacer 226 comprise holes for accepting wall pin 228 therethrough to allow the base arms 224 to rotate about wall axis 230. Arm mount system 216 further comprises an extension arm 232 rotatably carried between base arms 224 and spaced by extension spacers 234. Base arms 224 and extension arm 232 comprise hole for receiving an extension arm pin (not shown) into base arms 224 and through extension arm 232 and extension spacers 234 so that extension arm 232 can rotate about extension axis 236. Arm mount system 216 further comprises a hanger 238 rotatably mounted to extension arm 232 about hanger axis 240 using a hanger pin 242. Hanger 238 further comprises holes for accepting mounting bolts 244 therethrough to allow connection of nozzle 218 to hanger 238 in a rotatable manner about nozzle axis 246.

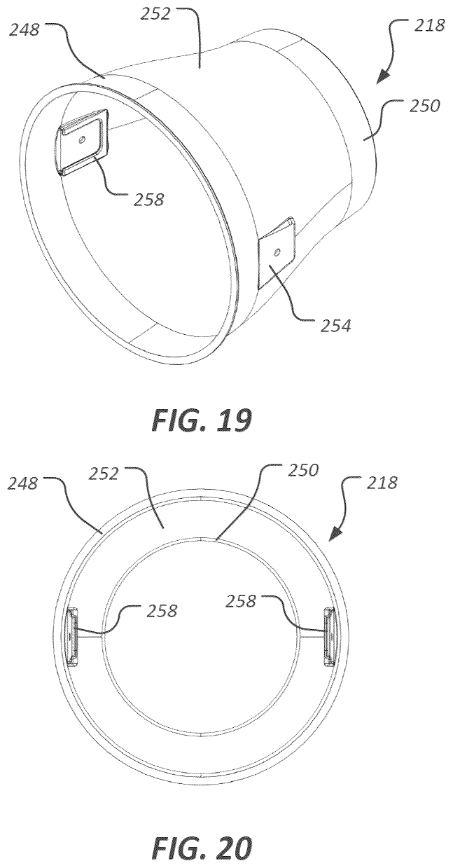

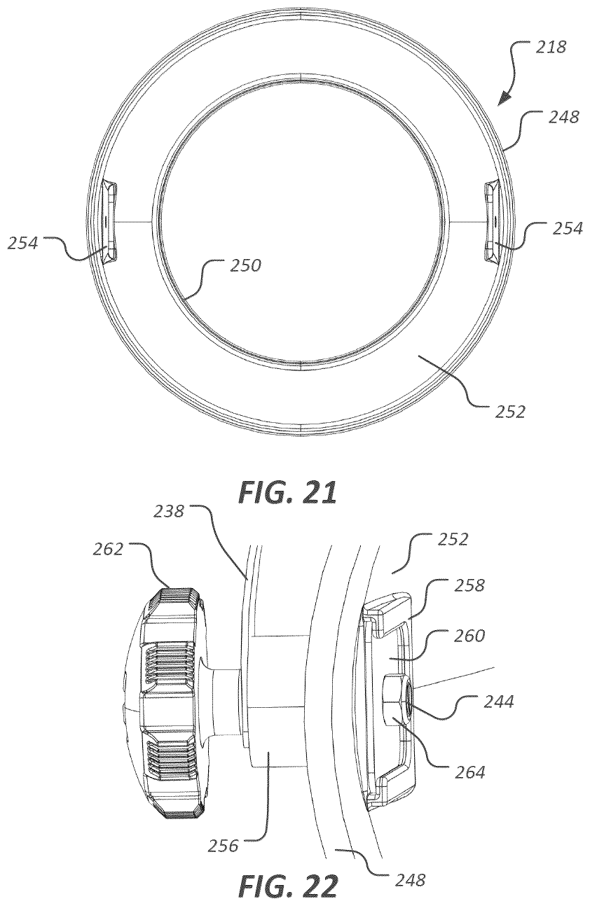

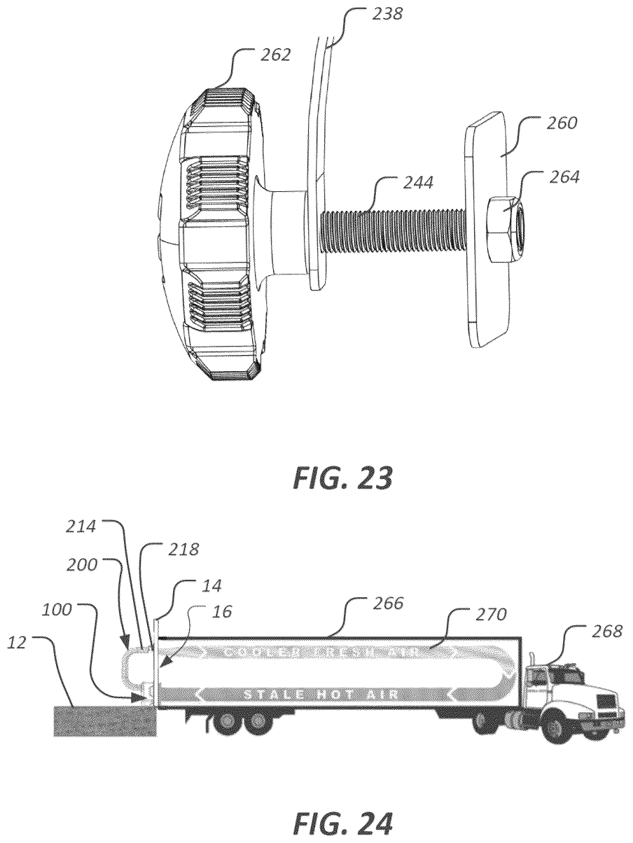

Referring now to FIGS. 19-21, nozzle 218 is shown in isolation. Nozzle 218 is generally tubular and comprises an inlet ring 248 having a first diameter, an outlet ring 250 having a second diameter smaller than the first diameter, and a reducing wall 252 joining the inlet ring 248 to the outlet ring 250. Nozzle 218 further comprises two mounting pads 254 carried at least partially by the exterior of the reducing wall 252. The mounting pads 254 provide substantially flat surfaces for abutment with cylindrical spacers 256 shown in FIG. 22. Mounting pads 254 also comprise holes for receiving mounting bolts 244 therethrough. Nozzle 218 also has two receivers 258 at least partially carried by an inner surface of the reducing wall 252. The receivers 258 comprise overhanging wall protrusions configured to form a slot for receiving nozzle mount plates 254 therein. In this embodiment, the receivers 258 and nozzle mount plates 260 comprise complementary rectilinear shapes that provide a simplified slide-on mounting feature between the nozzle 218 and the hanger 238. The nozzle mount plates 260 and related assembly are best shown in FIGS. 22 and 23. Mounting bolts 244 also carry a tightening knob 262 for screwing the mounting bolt 244 into nut 264 so that the hanger, 238, spacer 256, reducing wall 252, and nozzle mount plates 260 can be sandwiched tightly between the knob 262 and nut 264.

Referring now to FIG. 24, an ECS 100 having an ODS 200 is shown as configured to deliver air cooled by evaporative cooling action of the ECS 100 via ODS 200 to a trailer 266, positioned by a semi-truck 268, into a docked position relative to dock doorway 16 of a shipping dock environment 10. In this embodiment, nozzle 218 is positioned using arm mount system 216 to an upper corner location of dock doorway 16 so that cooled air exits nozzle 218 into an upper side portion of trailer 266. Airflow path 270 shows a simplified schematic representation of the flow of air ejected from ODS 200. More specifically, the cool air can enter trailer 266 in an upper portion of trailer 266 and warmer air can flow back out of trailer at a lower portion of trailer 266.

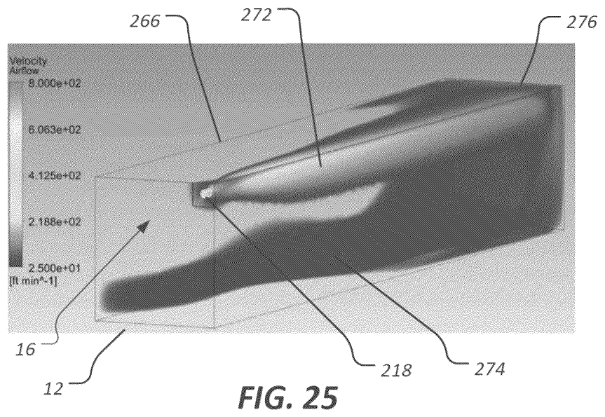

Referring now to FIG. 25, a computational airflow velocity analysis of air ejected from nozzle 218 into trailer 266 is shown. A benefit of using a cross-sectional reducing flowpath of nozzle 218 is that airflow velocity is increased as ejected from nozzle 218. The higher velocity airflow 272 is generally more tightly formed as compared to conventional fan outputs, and therefore, can reach a far end 276 of trailer 266 without substantial stagnation. In other words, ECS 100 with the aid of ODS 200 can deliver evaporatively cooled air far into trailer 266 whereas conventional delivery methods tend to spread air over greater cross-sectional areas near an entrance of the trailer 266 which leads to stagnation and failure of cooled air reaching far into trailer 266. In this embodiment, cooler higher velocity airflow 272 enters trailer 266 near an upper side of trailer 266 and reaches far end 276 of trailer before falling, reflecting, and returning back toward an entrance of trailer 266 near dock doorway 16. In some embodiments, air ejected from nozzle 218 can be substantially laminar as compared to conventional fan outputs, thereby ensuring deep reach of cooled air into trailer 266. In some cases, ECS 100 is situated between dock doorways so that air taken in by ECS 100 is not primarily air that is immediately leaving trailer 266. In cases where air temperatures within shipping dock environment 10 are cooler than air exiting trailer 266, improved cooling can be achieved.

It will be appreciated that in alternative embodiments, mechanisms other than arm mount system 216 can be used to selectively locate nozzles 218 relative to dock doorways 16. Further, it will be appreciated that nozzles shaped differently from nozzle 218 can be utilized to provide relatively high velocity air outputs and/or relatively laminar air outputs to similarly reach deep recesses of trailers 266 or other substantially enclosed structures so that evaporatively cooled air can be selectively aimed to produce the airflows demonstrated herein or to selectively target a location within a substantially enclosed structure without prematurely stagnating.

Still further, it will be appreciated that while the ECS 100 is a system that most generally receives environmental air on a first side and expels air from the same side, alternative embodiments of ESCs are contemplated that receive environmental air or intake air on a first side and expels air from a different side. More specifically, it is contemplated that an alternative ECS can receive air on a first side and expel air on a second generally opposing side. It is further contemplated that an alternative embodiment of an ECS can receive air on a first side and expel air on any other side. Additionally, in some embodiments, a secondary duct can be utilized in association with an ECS air intake so that air exiting a substantially enclosed structure, such as a trailer, can be fed back into the ECS for further evaporative cooling. In some cases, by receiving and expelling air on different sides of an ECS can allow locating the ECS at different locations near the substantially enclosed structures being cooled.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{EL}, and an upper limit, Rᵤ, is disclosed, any number falling within the range is specifically disclosed. In particular, the following numbers within the range are specifically disclosed: R=Rₛ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. An evaporative cooling system (ECS) having an output direction system (ODS), comprising:
an outer housing of the ECS;
a nozzle configured to receive evaporatively cooled air from the ECS; and
a mechanism for selectively moving the nozzle relative to the outer housing, wherein the nozzle is located remote from the outer housing.

2. The ECS of claim 1, wherein the mechanism is an arm mount system.

3. The ECS of claim 2, the arm mount system comprising:
axes of rotation sufficient for orienting the nozzle in substantially any desired direction.

4. The ECS of claim 1, wherein the nozzle comprises an inlet ring having a first diameter and an outlet ring comprising a second diameter smaller than the first diameter.

5. The ECS of claim 4, wherein the inlet ring is connected to the outlet ring by a reducing wall.

6. The ECS of claim 4, further comprising:
a duct attachment comprising a flange having a profile that is complementary to a profile of the outer housing.

7. The ECS of claim 6, wherein the duct attachment comprises a duct connection ring.

8. The ECS of claim 7, wherein the duct connection ring is connected to the flange by a converging wall.

9. The ECS of claim 8, wherein the duct attachment is configured to receive air from the ECS with a cross-sectional area greater than a cross-sectional area of an output of the duct connection ring.

10. The ECS of claim 9, further comprising:
a flexible duct connected to the duct connection ring and a nozzle of the ODS.

11. The ECS of claim 10, wherein the ODS comprises an arm mount system.

12. A nozzle for receiving air evaporatively cooled by an evaporative cooling system (ECS), the nozzle comprising:
an inlet ring comprising a first diameter; and
an outlet ring comprising a second diameter smaller than the first diameter.

13. The nozzle of claim 12, further comprising:
a reducing wall connected between the inlet ring and the outlet ring.

14. The nozzle of claim 13, wherein the reducing wall carries a mounting pad on an exterior of the reducing wall.

15. The nozzle of claim 14, wherein the mounting pad is substantially flat and comprises a hole therethrough.

16. The nozzle of claim 13, wherein the reducing wall carries a receiver on an interior of the reducing wall.

17. The nozzle of claim 16, wherein the receiver forms a slot for receiving a nozzle mount plate therein.

18. The nozzle of claim 17, wherein the receiver comprises a hole therethrough.

19. A method of cooling a substantially enclosed structure, comprising:
providing an evaporative cooling system (ECS);
operating the ECS to evaporatively cool air and eject the evaporatively cooled air;
providing an output direction system (ODS);
receiving the evaporatively cooled air from the ECS and into the ODS;
transporting the evaporatively cooled air to a location remote from the ECS via the ODS; and
outputting the evaporatively cooled air from the ODS through a nozzle.

20. The method of claim 19, further comprising:
ejecting the evaporatively cooled air from the nozzle into an upper portion of a substantially enclosed structure.
